(19) United States
(12) Patent Application Publication
(10) Pub. No.: US 2025/0010710 A1
(43) Pub. Date: Jan. 9, 2025

(54) VEHICLE CONTROL DEVICE

(71) Applicant: TOYOTA JIDOSHA KABUSHIKI KAISHA, Toyota-shi (JP)

(72) Inventors: Takeru SHIRASAWA, Sunto-gun (JP); Masaaki Sato, Sunto-gun (JP); Teruaki Haibara, Ashigarakami-gun (JP); Yusuke Saito, Gotenba-shi (JP)

(73) Assignee: TOYOTA JIDOSHA KABUSHIKI KAISHA, Toyota-shi (JP)

(21) Appl. No.: 18/674,260

(22) Filed: May 24, 2024

(30) Foreign Application Priority Data
Jul. 5, 2023 (JP) 2023-110933

(51) Int. Cl. B60K 28/10; H02J 7/00

(52) U.S. Cl. CPC B60K 28/10; H02J 7/0042

(57) ABSTRACT

A vehicle control device mounted on a vehicle capable of external charging, the vehicle control device being configured to: control to cause a state of the vehicle to a first state, in which a movement of the vehicle is prohibited, when receiving an instruction signal from an automatic charging device, which automatically connects a charging connector to a charging port; and release the first state under all of the following conditions are satisfied: a) there is a request for releasing the first state by a user of the vehicle while the vehicle is controlled under the first state, b) the charging connector is not connected to the charging port, and c) there is no obstacle in a traveling direction of the vehicle.

### CROSS-REFERENCE TO RELATED APPLICATION(S)

The present application claims priority to and incorporates by reference the entire contents of Japanese Patent Application No. 2023-110933 filed in Japan on Jul. 5, 2023.

### BACKGROUND

The present disclosure relates to a vehicle control device.

Japanese Laid-open Patent Publication No. 2010-234925 discloses a charging connector of the charging facility to perform external charging in a state of being connected to the charging port of the vehicle. In this vehicle, the ignition operation by the user is disabled when the lid of the charging port is open in order to prevent accidental starting during charging operation.

### OVERVIEW OF THE INVENTION

### Summary

There is a need for providing a vehicle control device capable of controlling a vehicle on the assumption that external charging is performed using an automatic charging device in a parking lot or the like.

According to an embodiment, there is provided a vehicle control device mounted on a vehicle capable of external charging, the vehicle control device being configured to: control to cause a state of the vehicle to a first state, in which a movement of the vehicle is prohibited, when receiving an instruction signal from an automatic charging device, which automatically connects a charging connector to a charging port; and release the first state under all of the following conditions are satisfied: a) there is a request for releasing the first state by a user of the vehicle while the vehicle is controlled under the first state, b) the charging connector is not connected to the charging port, and c) there is no obstacle in a traveling direction of the vehicle.

### BRIEF DESCRIPTION OF THE DRAWINGS

FIG. 1 is a schematic diagram for explaining a vehicle in an embodiment; and

FIG. 2 is a sequence diagram illustrating the control of the automatic charging device and the vehicle.

### DETAILED DESCRIPTION

In the related art, a system is contemplated for automatically connecting the charging connector to the charging port using an automatic charging device, such as a mobile robotic arm. The automatic charging equipment runs autonomously to the front of the charging port, and the charging connector can be connected or disconnected. However, the configuration described in Japanese Laid-open Patent Publication No. 2010-234925 was not assumed to use an automatic charging device such as a mobile robot arm.

Hereinafter, a vehicle control apparatus according to an embodiment of the present invention will be specifically described. Note that the present invention is not limited to the embodiments described below.

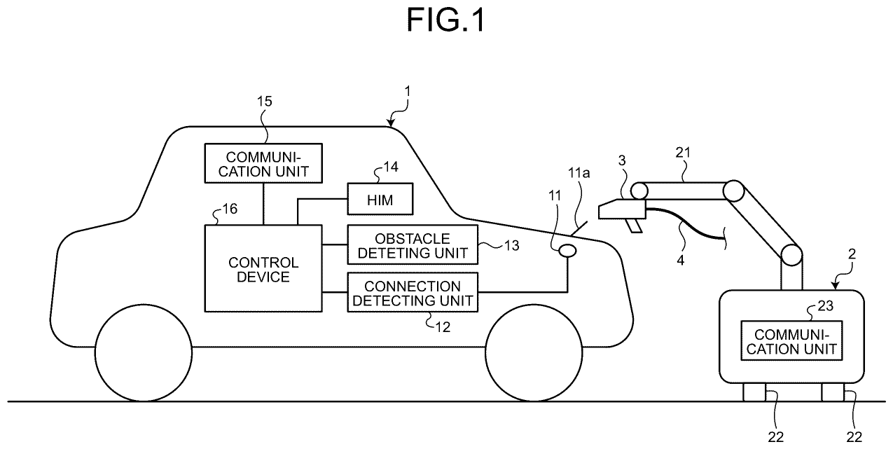

FIG. 1 is a schematic diagram for explaining a vehicle in the embodiment. A vehicle 1 is an electric vehicle capable of external charging, and it is possible to store power supplied from an external power source in the battery. The vehicle 1 is composed of a battery electric vehicle (BEV) and a plug-in hybrid electric vehicle (PHEV). The vehicle 1 can receive charging operation by the automatic charging device 2. The automatic charging device 2 is configured to be able to automatically connect the charging connector 3 to the charging port 11 of the vehicle 1. The charging connector 3 is electrically connected to an external power source via a charging cable 4. The charging connector 3 and the charging cable 4 are provided in the charging facility. This charging facility is installed in parking lots, etc. The automatic charging system including the automatic charging device 2 is a system for automating the charging of the vehicle 1.

The vehicle 1 includes a charging port 11, a connection detecting unit 12, an obstacle detecting unit 13, a HIM 14, a communication unit 15, and a control device 16.

The charging port 11 is a connection port to which the charging connector 3 is connected. The charging port 11 is configured to include a charging terminal. The vehicle 1 has a lid 11a of the charging port 11. The lid 11a is configured to be able to open and close from the outside of the vehicle 1. The charging port 11 and the lid 11a is provided, for example, in the front of the vehicle 1. With the lid 11a open, the user or the automatic charging device 2 of the vehicle 1 can connect the charging connector 3 to the charging port 11. In the state in which the lid 11a is closed, the charging connector 3 is disconnected from the charging port 11.

The connection detecting unit 12 detects that the charging connector 3 is connected to the charging port 11. When the charging connector 3 to the charging port 11 is connected, communication is performed between the vehicle 1 and the charging facility. For example, CAN communication or power line communication is performed. The connection detecting unit 12 detects the connection of the charging connector 3 by detecting that CAN communication with the charging facility. The connection detecting unit 12 outputs a detection signal to the control device 16 when detecting the connection of the charging connector 3.

The obstacle detecting unit 13 detects an obstacle existing in the vicinity of the vehicle 1. The obstacle detecting unit 13 can detect the obstacle when an obstacle such as the automatic charging device 2 is present in the vicinity of the vehicle 1. The obstacle detecting unit 13 is an obstacle detecting sensor constituted by, for example, a Lidar, a millimeter-wave radar, an ultrasonic sensor or the like. The obstacle detecting unit 13 can detect an obstacle located in the traveling direction of the vehicle 1, that is, the front and rear of the vehicle 1. The obstacle detecting unit 13 outputs the detection signal to the control device 16 when detecting an obstacle around the vehicle 1.

The HIM 14 is disposed in the vehicle 1 cabin and is configured by, for example, a car navigation device. When the HIM 14 is a car navigation device, the screen operation by the user is detected when the screen of the car navigation device is operated by the user. When the HIM 14 receives an operation from the user of the vehicle 1, the HIM 14 outputs a signal which has detected the operation to the control device 16.

The communication unit 15 performs wireless communication with an external device. The communication unit 15 is configured to allow wireless communication with the automatic charging device 2. Radio communication is capable of communication methods such as Wi-Fi (registered trademark). The communication unit 15 outputs the information obtained by the wireless communication to the control device 16. The communication unit 15 is controlled by the control device 16.

The control device 16 is an electronic controller for controlling the vehicle 1. The control device 16 executes various controls based on signals from various sensors. For example, the control device 16 executes the automatic charging control for performing external charging using the automatic charging device 2 in a state where the wireless communication between the vehicle 1 and the automatic charging device 2 is established.

The automatic charging device 2 is a device capable of autonomous running, for example, provided in a parking lot. The automatic charging device 2 is provided near the charging facility in a state independent from the charging connector 3. When the vehicle 1 is parked in the parking space, the automatic charging device 2 autonomously travels to the front of the charging port 11 of the vehicle 1, performs a charging operation by opening the lid 11a and connecting the charging connector 3 to the charging port 11.

The automatic charging device 2 includes a robot arm 21, wheels 22, and a communication unit 23.

The robot arm 21 is an arm which is movable when performing the charging operation. The automatic charging device 2 is configured to allow the robot arm 21 to operate freely. The robot arm 21 is controlled by a control device mounted on the automatic charging device 2. The robotic arm 21 includes a holding portion capable of holding the charge connector 3 and an operating portion capable of opening and closing the lid 11a.

Wheel 22 functions as a drive wheel of the automatic charging device 2. The controller of the automatic charging device 2 controls the driving of the wheels 22, and the wheels 22 can be steered, thereby changing the traveling direction of the automatic charging device 2 in a desired direction. For example, the automatic charging device 2 is mounted a motor, the power output from the motor is transmitted to the wheel 22.

The communication unit 23 performs wireless communication with the vehicle 1. The communication unit 23 can perform wireless communication with the communication unit 15 of the vehicle 1. The communication unit 23 is controlled by the controller of the automatic charging device 2. For example, when starting the charging operation to the vehicle 1 stopped in the parking space, the communication unit 23 transmits an instruction signal for prohibiting the movement of the vehicle 1 to the vehicle 1. Then, when the charging operation by the automatic charging device 2 is completed, the communication unit 23 transmits a release signal for releasing the state of prohibiting the movement of the vehicle 1.

In the automatic charging system including the automatic charging device 2 configured as described above, in order to prevent the vehicle 1 from mistakenly starting in a state where the charging connector 3 is connected to the charging port 11, an instruction signal is transmitted from the automatic charging device 2 to the vehicle 1 before the start of the charging operation. By receiving the instruction signal by the vehicle 1, the control device 16 preforms control to cause the vehicle 1 to be put into a state in which the movement of the vehicle 1 is prohibited (immobilization state). After completion of the charging operation, a release signal is transmitted from the automatic charging device 2 to the vehicle 1, by receiving the release signal by the vehicle 1, the control device 16 releases the immobilization state. However, when the vehicle 1 is in a state where the release signal is not transmitted due to trouble of the automatic charging device 2 while being controlled to the immobilization state, there is a concern that the vehicle 1 cannot be returned from the immobilization state. Therefore, in the vehicle 1, even if some trouble occurs in the automatic charging device 2 during the charging operation, it is configured to be able to release the immobilization state in the vehicle 1 side.

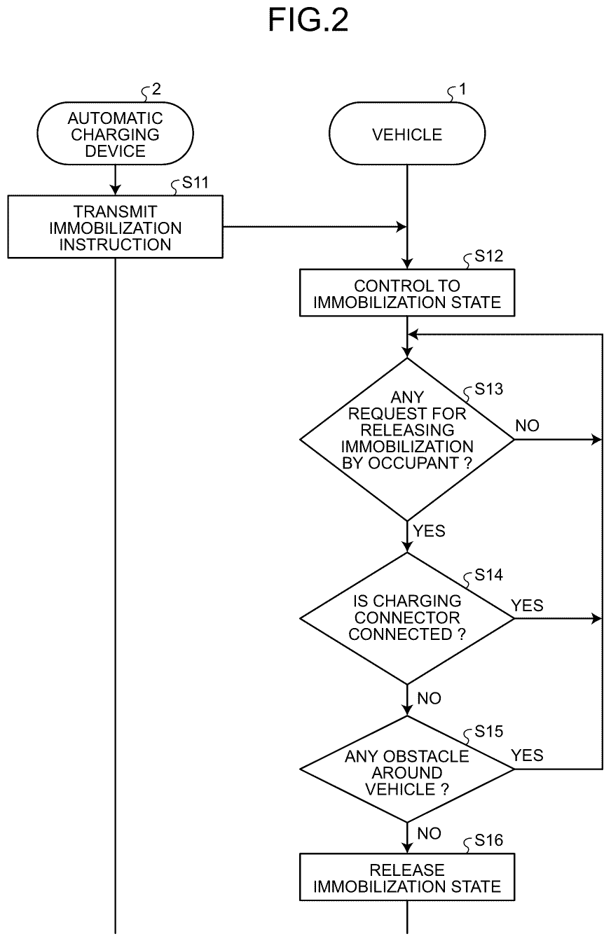

FIG. 2 is a sequence diagram illustrating an automatic charging control. The control illustrated in FIG. 2 is performed by the vehicle 1 and the automatic charging device 2 in a state where the vehicle 1 is stopped in the parking space.

The automatic charging device 2 transmits an instruction signal instructing the transition to a state of prohibiting the movement of the vehicle 1 (immobilization state) to the vehicle 1 stopped in the parking space (step S11). In step S11, an instruction signal instructing immobilization of the vehicle 1 is transmitted from the communication unit 23.

When the vehicle 1 receives the instruction signal from the automatic charging device 2, the control device 16 controls the vehicle 1 to immobilize state (step S12).

In step S12, the vehicle 1 is controlled to a condition where the moving of the vehicle 1 is prohibited. The state in which the movement of the vehicle 1 is prohibited (immobilization state) means a control state in which the driving of the driving wheels is prohibited although starting of the accessories is allowed. For example, the process in step S2 is performed prior to the starting of the charging operation by the automatic charging device 2. The control device 16 determines whether there is a request for canceling the immobilization state by the occupant (user) of the vehicle 1 (step S13). In step S13, the presence or absence of the cancellation demand by the occupant is determined by detecting the manipulation to the HIM 14. For example, by determining whether the screen operation of the car navigation device has been accepted, it is determined whether there is a request for canceling the immobilization state.

If it is determined that there is a release request of the immobilization state by the occupant of the vehicle 1 (YES in step S13), the control device 16 determines whether it is a state that the charging connector 3 is not connected to the charging port 11 (step S14). In step S14, whether the connection of the charging connector 3 to the charging port 11 is determined based on the detection signal from the connection detecting unit 12.

When it is determined that the charging connector 3 is not connected to the charging port 11 (YES in step S14), the control device 16 determines whether there is no obstacle around the vehicle 1 (step S15). In step S15, it is determined whether an obstacle such as the automatic charging device 2 exists in the traveling direction of the vehicle 1 on the basis of a detection signal from the obstacle detecting unit 13. Alternatively, the presence of absence of an obstacle in the vicinity of the vehicle 1 may be determined by the occupant of the vehicle 1 confirming the surroundings and performing a screen operation of the car navigation device by the occupant. That is, the determination may be made by the user's manual operation.

If it is determined that there is no obstacle in the vicinity of the vehicle 1 (YES in step S15), the control device 16 releases the immobilization state (step S16). In step S16, the state in which the moving of the car 1 is prohibited is canceled. By performing the process of step S16, the vehicle 1 is moved to a condition where the movement is permitted.

As illustrated in FIG. 2, even in a state in which the vehicle 1 is receiving the signal of the immobilization instruction from the automatic charging device 2, when a predetermined release condition is satisfied, the vehicle 1 can release the immobilization state. The release condition includes that there is an immobilization release request from the user, that the charging connector 3 to the charging terminal of the vehicle 1 is not connected, and that an obstacle such as an automatic charging device 2 is not detected around the vehicle 1.

As described above, according to the embodiment, even when some trouble occurs in the automatic charging device 2 during the charging operation, it is possible to cancel the immobilization state on the vehicle 1 side.

It is to be noted that the positions of the charging port 11 and the lid 11a is not limited to the front of the vehicle 1 and may be provided on the rear of the side and the vehicle 1 of the vehicle 1.

In the present invention, when in a state in which the movement of the vehicle is prohibited by an instruction from the automatic charging device such as a mobile robot arm, even if some trouble occurs in the automatic charging device, the state in which the movement of the vehicle is prohibited can be released from the vehicle side.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle control device mounted on a vehicle capable of external charging, the vehicle control device being configured to:
control to cause a state of the vehicle to a first state, in which a movement of the vehicle is prohibited, when receiving an instruction signal from an automatic charging device, which automatically connects a charging connector to a charging port; and
release the first state under all of the following conditions are satisfied:
a) there is a request for releasing the first state by a user of the vehicle while the vehicle is controlled under the first state,
b) the charging connector is not connected to the charging port, and
c) there is no obstacle in a traveling direction of the vehicle.

2. The vehicle control device according to claim 1, the vehicle control device being further configured to:
determines whether there is the request for releasing the first state by the user by detecting an operation by the user on a screen of a car navigation device of the vehicle while the vehicle is controlled under the first state.
